(19) United States
(12) Patent Application Publication
(10) Pub. No.: US 2012/0216445 A1
(43) Pub. Date: Aug. 30, 2012

(54) METHOD FOR KILLING TICKS AND OTHER VECTORS USING A HEATED WATER SYSTEM

(76) Inventor: Peter C. Aquilina, Seymour, CT (US)

(21) Appl. No.: 13/407,756

(22) Filed: Feb. 28, 2012

Related U.S. Application Data
(63) Continuation of application No. 61/447,623, filed on Feb. 28, 2011.

(51) Int. Cl. A01M 7/00

(52) U.S. Cl. 43/132.1

(57) ABSTRACT

A non-chemical, organic method to kill/control ticks and other vectors using heated water is disclosed. The method causes no immediate or residual toxicity to humans, pets, beneficial insects, and wildlife, and may be employed in both residential and commercial settings. The method employs water temperatures from about 145° F. to about 155° F. to kill/control ticks and other vectors without damaging plants. The method can be adapted to higher water temperatures to kill/control unwanted vegetation that is the primary habitat for ticks and other vectors, with the least environmental impact. Delicate plants can be pre-treated using a thermally-insulated backpack. A specialized nozzle for use in the present method is also disclosed.

### CROSS-REFERENCE TO RELATED APPLICATIONS

This application claims the benefit of U.S. Provisional Application Ser. No. 61/447,623, filed on Feb. 28, 2011, which is incorporated by reference herein.

### BACKGROUND OF THE DISCLOSURE

1. Field of the Disclosure

The present disclosure relates to a non-chemical, organic method for killing ticks and other vectors using a heated water system

2. Description of the Related Art

Many states, including all New England states, have notification laws that require customers provide written notice to adjacent residents and neighbors prior to an urban pesticide application. All pesticide applicators must be licensed and registered with the state.

Pesticides should not be applied on windy days to avoid drift to non-target areas, and for residential application, windows and doors of the home should be closed. Pesticides should be kept away from plants and play areas that are not targeted for treatment. Most tick control pesticides are for ornamental and turf use only and are not labeled for use on plants meant for human consumption. In addition, most of these chemicals are toxic to bees and should not be applied to areas with foraging bees. In addition, most of these pesticides are toxic to beneficial insects and invertebrates and even beneficial bacteria found in the top few inches of healthy soil. Pesticides should not be applied near wetlands, lakes, reservoirs, rivers, streams, marshes, ponds, estuaries, and commercial fish farm ponds or near coastal marshes or streams. Family members and pets, especially cats, should be kept off the pesticide-treated area for at least 12-24 hours.

Most of these pesticides contain a compound known as pyrethrin in the natural form (derived from the chrysanthemum flower), or more commonly are synthetic pyrethroids. Both are neurotoxins. The real concern about these pesticides is the longevity of the toxins when they come in contact with water. When allowed to completely dry, there is no residual toxicity or cancer-related risk. But when these chemicals come into contact with water and remain in liquid form, the toxicity and cancer risks remain. So much so, it has recently been shown that these compounds (and many others) seep into water wells and flow into watershed reservoirs, and sustain toxic and carcinogenic levels for years.

This means, for example, that any time a pesticide is applied, and there was a rain shower before the pesticide had adequate time to dry, or if the applicator made a judgment error and sprayed on a breezy day, which caused some drift into a nearby stream that he/she did not know was there, the result can be long-term unhealthy drinking and bathing water for residents and their families.

Current water treatment facilities cannot remove these toxic or carcinogenic compounds and chemicals from drinking water, nor can any known water filtration or purification process.

In addition, watershed areas which encompass a certain area around reservoirs and the aquatic ecosystems found in these reservoirs are steadily on the decline, and have been for at least 40 years. Much of this decline is due to pesticides in the water which kill the microorganisms that remove heavy metals and other toxins therein. Also, the vegetation of the watershed area, along with the microorganisms found in a healthy aquatic ecosystem of a typical reservoir, are the designed and intended natural filtration and purification processes even before the water is treated at the local water treatment plant. Without these purification processes taking place, there is no feasible way to remove toxins and carcinogens from the water supply. Even organic pesticides are toxic to fish and aquatic invertebrates. The only way to prevent this is to stop them from being introduced into the water supply altogether.

Traditionally, ticks and other vectors have been killed/controlled using pesticides and non-pesticides that are mixed in water and delivered to outdoor areas such as private homes, playgrounds, parks, etc., using a large or small holding tank which is then pressurized and fed through a hose to a high or low pressure nozzle. The mixture is then applied to grassy areas and/or vegetation areas where ticks and other vectors find a habitat. There are also granular pesticides and organic applications, which need water to activate. These are mostly applied to lawns and to low-cut grassy areas.

The benefit to killing/controlling populations of vectors, which is used herein to mean pathogen-carrying, blood-feeding insects, such as ticks, mosquitoes, black flies and fleas, is because of adverse health issues related to this group of blood-feeding insects, particularly ticks. Lyme Disease is the largest concern, but there are at least five other serious diseases associated with pathogen/disease-carrying insects (vectors). It is estimated that there may be as many as 20 million people infected with the pathogen that causes Lyme Disease in the Eastern United States alone, and its spread is a problem throughout the entire country, especially in coastal areas.

Ticks have a two-year life cycle. Ticks are typically found close to the ground because they need to be picked up by a host at least three times throughout their two-year life cycle. Ticks are located anywhere from ground level (during the egg and larvae stages), up to about 3 to 3½ feet off the ground during the adult stage. During the adult stage, ticks generally do not travel for distances of more than about 1 meter on their own; instead, ticks move by attaching themselves to a host animal, which they use for a blood meal, and for dispersal. A tick can also travel by attaching to a leaf that is blown in the air or along the ground. An ungorged adult tick (i.e., a tick that has not recently had a blood meal) is generally flat, disc-shaped, and does not possess great mass.

For these reasons, conventional methods that apply high-pressure heat/flame cultivation to a target area, at or around an angle of 75°-90° from horizontal (i.e., at or near perpendicular to the ground) is not desirable or effective to kill ticks, because ticks are able to sense the approaching heat and perform a defensive maneuver of releasing themselves from the vegetation perch, and are then propelled a safe distance away from the heat.

Thus, there's a delicate balance between effective insect mortality and the preservation of ornamental plants and vegetation, which tend to be sensitive to high temperatures.

### SUMMARY OF THE DISCLOSURE

The present disclosure provides a non-chemical, organic method for killing ticks and other vectors using heated water.

The method employs heated water having temperatures from about 145° F. to about 155° F. at the point of impact to kill ticks and/or other vectors without damaging hardy plants in the treated area. The heated water is the killing agent of the ticks and other vectors.

The present method can also be adapted to use higher water temperatures, from about 180° F. to about 210° F., to kill and control unwanted vegetation that is the primary habitat for ticks and/or other vectors, with the least environmental impact.

The heated water is applied to the treated area to have an angle of descent and flow rate that produce a low pressure liquid stream that douses the treated area and kills ticks and/or other vectors on their perch on ground vegetation and/or on the ground directly beneath their perch.

Heat-sensitive plants and vegetation, such as ornamental plants, can also be pre-treated with heated water by an applicator carrying a portable supply of heated water in a backpack water reservoir that is sprayed under ambient pressure produced by a gravity feed. As used in this application, the “applicator” is the person who is treating the area with heated water.

The method of the present disclosure causes no immediate or residual toxicity to humans, pets, beneficial insects, and wildlife, and may be employed in both residential and commercial settings.

By avoiding any and all toxins and/or organic killing agents with one or more chemical active ingredients, the present method achieves an environmentally-friendly method for effective and instant mortality to ticks and other vectors in desired and targeted outdoor areas. A further benefit of the present method and system is that effective treatment can be applied to outdoor areas without introducing any chemical or other substances that were not already present prior to treatment.

The present method has the least environmental impact of any organic or non-organic method currently available, while still giving the desired result of “cleansing” targeted outdoor areas of disease-carrying ticks and other vectors.

Also provided is a nozzle that is configured to apply heated water in a liquid stream that drenches the treated area without using high pressures. The nozzle can be shaped to provide a wide-angled, fan-shaped uniform arc of water. The nozzle also permits the applicator to control the flow rate of heated water. The nozzle tip may have one or more ribs that traverse the nozzle opening to create small water channels that straighten the flow of water before it leaves the nozzle.

The specialized nozzle can further have a heating element that can add heat to pre-heated water in the nozzle that permits the applicator to make adjustments to the water temperature, so that the water temperature at the point of impact (when it contacts the tick or vegetation) is the effective, desired temperature to kill ticks and other vectors. This adjustment can be varied by the applicator depending on outside air temperature, wind speed, etc., at the time that the heated water is applied to the treatment area.

### BRIEF DESCRIPTION OF THE DRAWINGS

FIG. 1 is an illustration of exemplary embodiments of the method and system of the present disclosure, including a water tank in a tank truck to pre-heat water. Another embodiment in FIG. 1 is provided where a small reservoir of heated water is carried by the applicator to the treatment area in a thermally-insulated back-pack.

FIG. 2 is an illustration of the outer structures of a nozzle that can be used in the method in FIG. 1.

FIG. 3 is an illustration of a top view of the nozzle in FIG. 2 showing the water-in chamber where water enters the nozzle, the other outer structures of the nozzle, and a temperature regulation system on the base portion of the nozzle.

FIG. 4 is an illustration of a top view of the nozzle in FIG. 2, showing the direction of water flow through the nozzle, and manual controls for temperature and power regulation, and a temperature sensing unit at the nozzle tip.

FIG. 5 is a schematic of the nozzle in FIG. 2, showing an embodiment of a U-shaped heating element inside the nozzle, and a direct view of the heating element through the opening that is the water-in chamber.

FIG. 6 is still another embodiment of the nozzle in FIG. 2, having a heating element configured in a coil to supply additional heat to the water, and also providing a direct view of the coiled heating element through the water-in chamber.

FIG. 7 is another exemplary embodiment of the nozzle that can be used in the method of the present disclosure that has a nozzle tip that is flared and flattened, and having ribs that separate the nozzle tip into several small water channels.

FIG. 8 is a side view of a portion of the nozzle head in FIG. 7, with a nozzle tip, elliptical-shaped nozzle tip opening, and ribs traversing the nozzle tip opening.

FIG. 9 is an enlarged view of the nozzle tip in FIG. 7.

FIG. 10 provides a view directly into the nozzle tip in FIG. 7, showing the flared nozzle tip, nozzle tip opening, and several ribs that create small water channels in the nozzle tip.

### DETAILED DESCRIPTION OF THE DISCLOSURE

The present disclosure provides a non-chemical, organic method for killing ticks and other vectors using heated water.

The heated water is the actual killing agent of the ticks and/or other vectors. Water, which is solely in its liquid phase, is the median/mode of transport of the heat energy.

The method of the present disclosure causes no immediate or residual toxicity to humans, pets, beneficial insects, and wildlife, and so may be employed in both residential and commercial settings. The method offers the eco-friendly benefit of effectively killing/controlling ticks and other vectors without introducing any chemicals into the treated area that were not already present in the area before treatment.

The present method employs heated liquid water temperatures from about 145° Fahrenheit (° F.) to about 155° F. at the point of impact to kill/control ticks and other vectors. The method is effective without damaging hardy plants, landscape or shrubbery.

The present method can also be adapted to use higher water temperatures, from about 180° F. to about 210° F., to kill and/or control unwanted vegetation that is the primary habitat for ticks and other vectors, with the least environmental impact.

An angled spray that impacts the treatment area at an average “angle of descent” at relatively low pressure is ideal for killing ticks and other vectors. As used herein, “angle of descent” is the angle, from horizontal (level ground), at which the heated water contacts the vegetation and ticks/vectors in the treatment area. In an embodiment of the present method, the angle of descent of the heated water on the treated area is about 45° (±15°) from horizontal. In a preferred embodiment of the method, a descent angle of about 40° to about 45° at the point of impact is used by the applicator. Because the applicator typically will swing the nozzle to drench the treatment area, the angle of descent at the point of impact will vary from moment to moment, but the average angle of descent should remain in the desired, effective range. Also, the spray of heated water is effectively applied where there is a distance from the nozzle to the treatment area that is about 15 to 30 feet (±5 feet), and is preferably applied by the applicator standing a distance of about 25 feet to about 30 feet from the treatment area, and applying the heated water in an arc that contacts the treatment area at the desired average angle of descent.

This angle of descent of the heated water kills the ticks and other vectors where they perch on vegetation, and avoids blowing the ticks and other vectors a safe distance away. If the vector is not immediately killed on the perch, the contact of heated water applied by this method forces the tick to drop to the ground within the immediate spray area, where it is killed with a second contact with heated water. This dual mechanism by which the present method operates provides a highly effective, and highly efficient, method to kill ticks and other vectors in the treatment area.

The flow rate of heated water that is used in the method is selected by the applicator to provide a drenching, dousing coverage of the treatment area with heated water. An exemplary embodiment of the present method uses a flow rate of heated water that is from about 25 to 30 gallons of water per minute, and that is applied by the applicator from about 25 feet to about 30 feet away from the target treatment area. This provides a low impact yet long range treatment that is time- and cost-effective to kill ticks and other vectors as compared with conventional methods.

The applicator typically employs a sweeping motion with the nozzle while applying the heated water to the treatment area, moving the nozzle up and down, and back and forth, to drench the target area, which will create small changes in the angle of descent (from changes in the arc of the heated water as it is applied) and distance to the treatment area/zone.

As used in this application, “vectors” is used to mean any pathogen-carrying, blood-feeding insect, including, but not limited to, ticks (and other arachnids), mosquitoes, black flies, and fleas.

Also, as used in this application, “water” and “heated water” mean only the liquid phase of water (H₂O), and excludes water in its gas phase, i.e., water vapor and/or steam.

In order to apply drench outdoor areas with the present method utilizing heated water, a nozzle that is able to “tweak” (i.e., make small adjustments to) the temperature of the water just before the water leaves the nozzle tip is desirable and cost effective, due to the resulting increase in energy efficiency, and is disclosed herein. A nozzle that contains a secondary heating element inside can be used for situations where water temperature is not completely controlled by heating with the primary heating element located on the vehicle (truck) that initially heats the water. As used in this application, to “tweak” the temperature means to “make small adjustments to” the temperature, usually by an amount of about 5-8° F.

As the heated water travels from the holding tank through the insulated hose the temperature may drop significantly, especially on long runs where the hose may need to carry the heated water 400 feet or more, and/or with cold ground and/or low ambient air temperatures. Low ambient air temperatures have to be accounted for and calculated into final adjustments on heat settings by the applicator, for both the primary heating element located in the holding tank, and the secondary heating element in the nozzle.

The two heating elements are integrated and synchronized by using a series of thermostats and a control module that automatically control the water temperature in conditions that are less than ideal. However, in most cases, the control module and the secondary heating element inside the nozzle will not be used, because the outside temperature does not affect the solo operation of the primary heating element in the holding tank. The objective of the present method is to achieve the desired, effective heated water temperature at the point of impact, and most of the time the primary heating element is sufficient to achieve this.

In an embodiment of the present method, the primary heating element is located in a holding tank, which is mounted on a truck or in a large van. This arrangement would be similar to a tank truck as used in the dairy industry and known as a Homogenization Truck. The heating elements can be upgraded, and an external pump can be added. The remaining upgrades or retrofits include the control module for automatically maintaining water temperature, battery storage if solar power is used, and/or an alternative energy source.

Another embodiment of the method provides for heating water with a “flash boiler,” which is commonly used in homes and health clubs to instantly heat water, and therefore not requiring a holding tank at all, but just a continuous source of water. The advantage of this approach is that it is adaptable to use the available water source on each property. This method is flexible to use the least amount of energy for water heating. If this method does achieve Highest Energy Efficiency, this may occur for many reasons, not the least of which would be the lower fuel consumption from job to job because of the absence of extra weight from the holding tank. For sites that do not have a usable water source, a tank truck is required.

In another embodiment, the nozzle contains a cold water mixing valve placed after the heating element, but before the temperature sending unit located at the very tip of the nozzle. There are certain plants, such as delicate flowers and other desirable vegetation, that are particularly susceptible to heat stress and damage. Therefore, an instantaneous lowering of the water temperature, on demand, to a water temperature that is tolerated by delicate plants is another option of the present method. This method effectively knocks ticks and other vectors off of their perch on vegetation, and onto the ground, because even at a temperature range of about 120° F. to about 130° F., ticks are thrown into temporary heat shock and cannot maintain their grip on vegetation. However, this temperature range will not harm delicate plants. Furthermore, the higher water temperature can then be instantly recovered and used to kill the desired targets on the ground, without fear of damaging delicate foliage or plants. With proper technique, and special care not to over-apply the heated water of the present method, the root systems of even the most delicate plants are preserved.

In order to save energy and further simplify the heating nozzle, an extra step in the application process can be utilized, in keeping with the primary objectives of personalizing each application and protecting each property's delicate plants and flowers. In this embodiment of the method, a primary application/pre-treatment is done with a back-pack sprayer, rigged with a large but manageable thermal tank containing heated water that, when applied, is within about 120° F. to about 130° F. at the point of impact. The applicator would then target only the delicate plantings on the property, and return immediately with the second treatment of the heated water utilizing the nozzle, which is the most time/cost effective. This second treatment would be applied to the ground only, in the immediate area of the delicate plant(s) and planting(s). Then the applicator advances to the remaining areas of the property that only require the nozzle application because of the absence of delicate (yet desirable) plants and shrubs.

An additional layer of complexity, and therefore cost, can be removed be adapting the nozzle to the present method. For example, a manual power control for the heating element can be added inside the nozzle, and a temperature gauge to monitor water temperature as it exits the nozzle tip. Both devices are easily mounted on the nozzle, and the entire nozzle can easily be built from readily available parts, components, and materials. A prototype successfully and instantly raised the temperature of cold tap water about 5° F. This is all that is necessary to tweak the water temperature in less-than-ideal weather conditions.

In addition, the applicator who is performing the treatment will have extensive knowledge of heat loss per volume/rate applied, per distance applied, and at what air temperature. Wind speed will also have to be calculated and accounted for in the proportionate heat settings. A small chart containing these calculations could be placed on the nozzle to enable the applicator to quickly and easily reference the required temperature settings. By manually monitoring and controlling the heating nozzle, the complexity and cost of having an automated system would not be necessary. Therefore, the control module and integration of the thermostats would not be required.

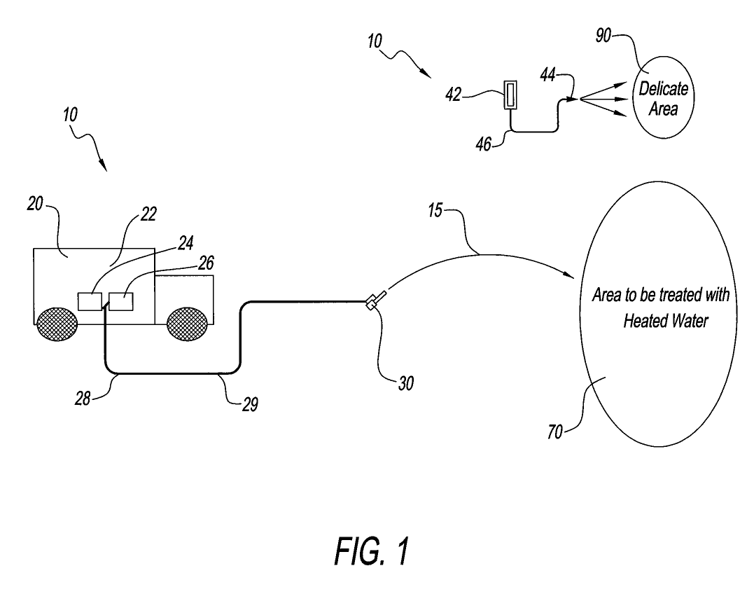

Referring now to the drawings, and in particular, FIG. 1, there is provided an exemplary embodiment of a method for treating outdoor areas to kill/control ticks and other vectors by application of heated water to the targeted area, the method generally represented by reference numeral 10. In method 10, a tank truck 20 is equipped with an insulated hot water tank 22, water pump 24, and electrical generator 26 to heat water used for the treatment. Tank truck 20 is equipped with one or more heating elements (not shown) to heat the water. To regulate temperature of the heated water, tank truck 20 has a thermostat (not shown) to measure water temperature and a temperature gauge (not shown) to display water temperature.

Heated water from insulated hot water tank 22 flows out of tank truck 20 through an insulated hot water hose 28. Water pump 24 propels the water under pressure through hose 28. Hose 28 may have an electrical power cord 29. Heated water flows through hose 28 to a nozzle 30. Heated water is sprayed from nozzle 30 which is angled upward by the applicator so that the heated water is sprayed in an arc 15 to outdoor area 70 that is to be treated to kill ticks and other vectors. Arc 15 is the angle of descent of the heated water on treatment area 70. A person who is treating the outdoors area, who is called the “applicator” in this application, directs the flow of heated water onto areas 70 to be treated by moving hose 28 and nozzle 30.

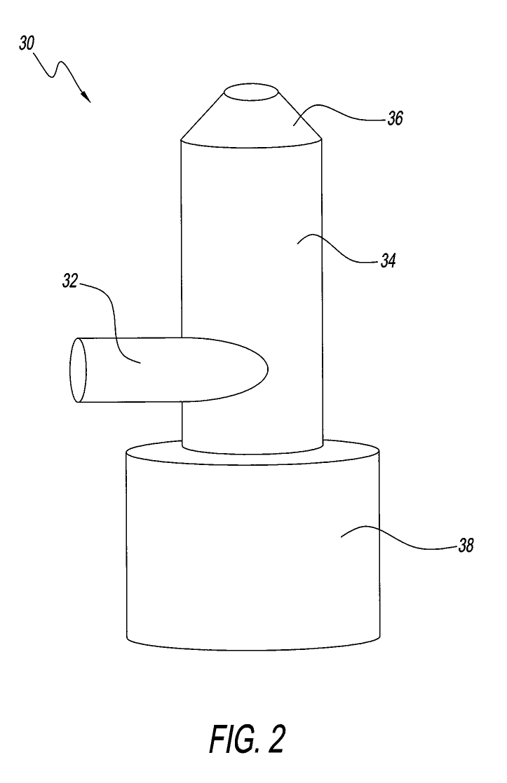

As shown in FIGS. 2 to 5, nozzle 30 has a “water-in” chamber 32, and a cylinder nozzle head 34 that is tapered at a nozzle tip 36, a wiring and component housing unit 38 opposite said nozzle tip, and a power cord 39. Heated water enters nozzle 30 via chamber 32. The water then flows through chamber 32 into cylinder nozzle head 34, and then flows into nozzle tip 36, from where the heated water exits nozzle 30. Chamber 32 is illustrated as oriented at about 90° relative to the longitudinal direction of cylinder nozzle head 34, and is positioned at or near the base of the nozzle head.

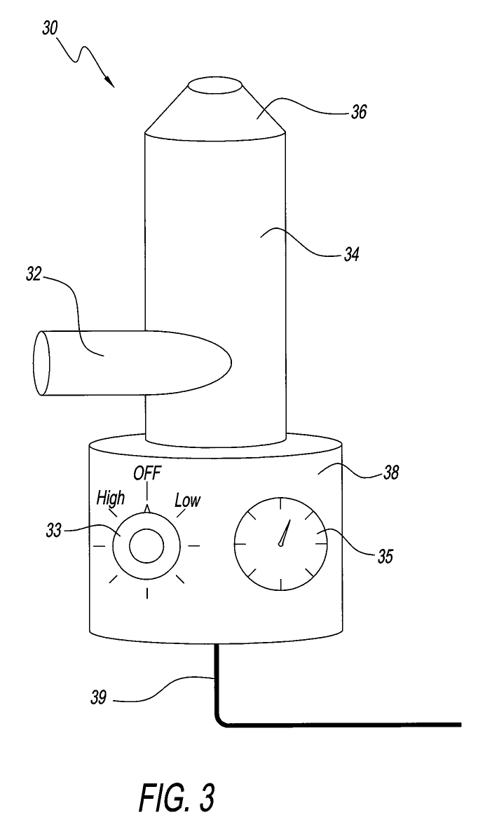

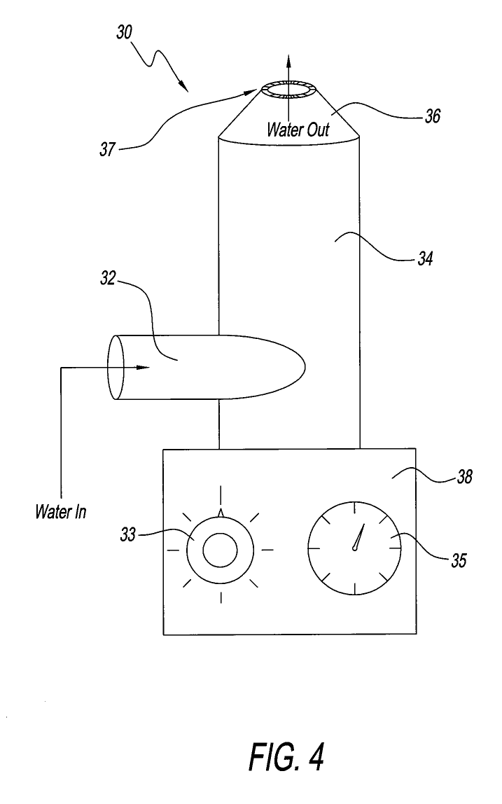

Referring now to FIGS. 3 and 4, wiring and component housing unit 38 has a power control dial 33 that controls electrical power supplied to heating element(s) 31. Power control dial 33 can be manually adjusted by the applicator to regulate temperature. Alternatively, the entire system could automatically control water temperature using a control module and a series of thermostats. Wiring and component housing 38 also has a temperature gauge 35 which displays temperature of the heated water exiting at nozzle tip 36.

Referring to FIG. 4, nozzle 30 can have a temperature sending unit 37 at nozzle tip 36 that measures the temperature of the heated water as it leaves nozzle 30. The temperature is displayed on temperature gauge 35. Alternatively, temperature data from temperature sending unit 37 could be integrated and synchronized with a module to automatically control water temperature.

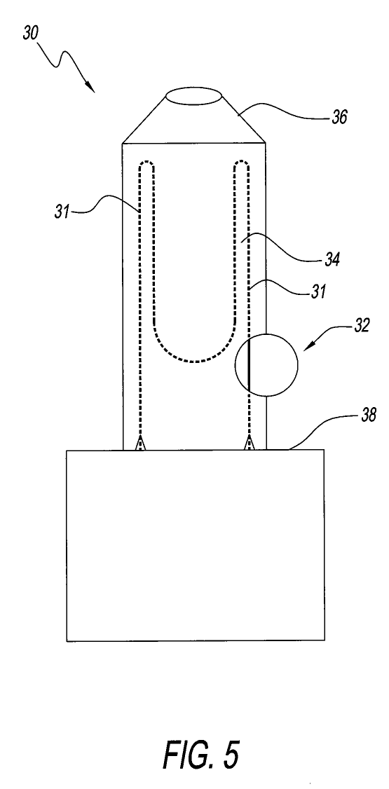

Referring now to FIG. 5, nozzle 30 can have one or more heating elements 31. Heating element 31 is preferably in nozzle head 34 and/or in nozzle tip 36. In the exemplary embodiment shown in FIG. 5, when nozzle 30 is not connected to hot water hose 28, a portion of a heating element 31 can be seen by the applicator when looking through chamber 32 into the interior of nozzle 30.

As shown in FIG. 5, water-in chamber 32 can be placed “off-center” in relation to nozzle head 34 to create a “swirling effect” of heated water in nozzle head 34 and nozzle tip 36. Additional “back-pressure” can be generated by using a chamber 32 having a larger diameter than nozzle tip 36. The swirling effect and back-pressure cause the water in nozzle 30 to pass over heating elements 31 more often and creates optimal heat transfer to the water.

The heated water exits nozzle 30 under pressure, preferably a low pressure, low-impact manner that drenches an area of landscape or plants much like would occur during a drenching rain. The heated water preferably exits nozzle 30 under low pressure in a vertical, fan-shaped stream to cover as much area as possible with the heated water in a short time. Preferably, the water stream is an arc that contacts the foliage/landscape being treated at least 15 feet from the applicator, and preferably about 20 to 30 feet from the applicator, and covering an area that is from the ground level to about three (3) feet to four (4) feet above the ground, where tocks and other vectors reside.

Referring again to FIG. 1, another exemplary embodiment of a method for treating an area with heated water to kill/control ticks and other vectors, represented generally by reference numeral 40, is provided. In method 40, water is heated from an external source and transferred into a thermally-insulated back-pack 42. Thermal back-pack 42 is insulated to reduce heat loss, and is portable by an applicator (not shown) who can carry thermal back-pack 42 to a treatment area 90. The applicator controls the direction and amount of flow of heated water onto area 90 by directing nozzle 44. Thermal back-pack 42 and nozzle 44 are connected by an insulated hot water hose 46.

Method 40 can be used to pre-treat area 90 that has delicate or sensitive plant and/or animal species that require precise control of the amount and/or temperature of heated water applied thereto. Nozzle 44 can be an ordinary water nozzle, or, alternatively, can have components that measure and display the temperature of the heated water, and/or one or more heating elements (not shown) that transfer additional heat energy to the water in nozzle 44.

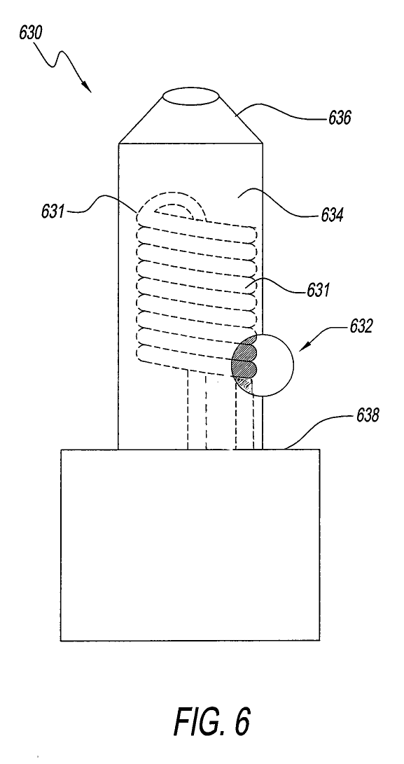

Referring to FIG. 6, nozzle 630 has one or more heating elements 631 in a coiled configuration positioned inside nozzle head 634 and/or in nozzle tip 636. As shown in FIG. 6, when nozzle 630 is not connected to the hot water hose, a portion of the coiled heating element 631 can be seen through the water-in chamber opening.

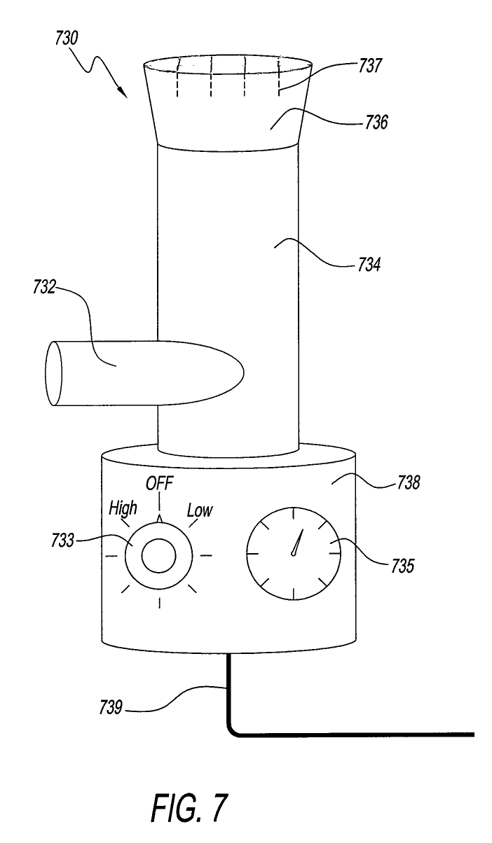

In FIG. 7, an embodiment of a nozzle is provided having a flared, flattened nozzle tip. Nozzle 730 has a “water-in” chamber 732, a nozzle head 734 (also a water heating chamber), and a nozzle tip 736 that forms a nozzle tip opening through which the heated water exits nozzle 730. Nozzle tip 736 is flared and tapered or flattened, and has one or more ribs 737 that traverse the nozzle tip opening, creating at least two separate water paths in the nozzle tip. The tapered or flared nozzle tip creates additional back pressure, rotation, and swirling effects to the water in the nozzle head (heating chamber), thereby increasing the efficiency of heat transfer from the heating element to the water. The water paths that are formed by ribs 737 also have a straightening effect on the swirling, heated water that exits nozzle 730, so that the heated water sprayed on the treatment area is projected from the nozzle in a gentle, wide-angle, uniform arc.

Nozzle 730 also has a wiring and component housing unit 738 opposite the nozzle tip, and a power cord 739. Heated water enters nozzle 730 via water-in chamber 732. The water then flows through water-in chamber 732 into the nozzle head 734, which serves as a secondary water heating chamber. The water then flows into nozzle tip 736, through which the heated water exits nozzle 730. Water-in chamber 732 is oriented at about 90° relative to the longitudinal direction of nozzle head 734, and at or near the base of the nozzle head. Since water-in chamber 732 is positioned slightly off-center in relation to nozzle head 734, the heated water entering the nozzle head creates a swirling effect. Also, because nozzle head 734 is slightly tapered, the water inside the nozzle creates a slight back-pressure that, in combination with the swirling, cause the water to pass over a heating element in the chamber (if present). As noted above, the water paths formed by ribs 737 produce a straightening effect on the heated water before the water exits the nozzle.

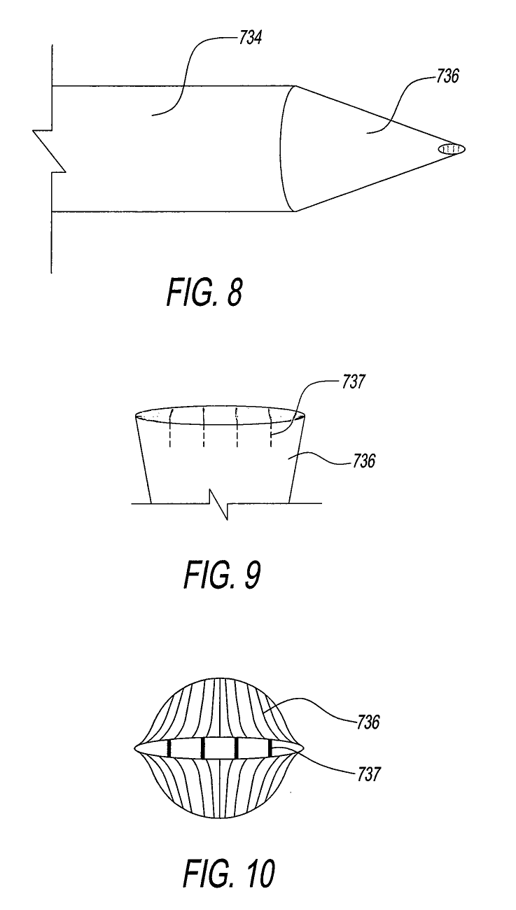

FIGS. 8 to 10 illustrate detailed view of nozzle 730. FIG. 8 illustrates the relation of nozzle head 734 and nozzle tip 736, where nozzle tip 736 is flared and flattened and has an elliptical nozzle tip opening. FIG. 9 shows nozzle tip 736 that is flared and flattened, with four ribs. 737 that create 5 separate water paths through nozzle tip 736. The flare can be about 5° to about 10° on either side. The flare angle provides a fan of heated water that is from about 3 feet to about 10 feet wide across at the point of impact, which can vary depending on the sweeping motions by the applicator during administration of the heated water to the treatment area. FIG. 10 is a view straight down the nozzle tip, illustrating the flared, flattened structure of nozzle tip 736, and four ribs 737 that create five separate water paths.

As used in this disclosure, the word “about” for temperatures, dimensions, weights, angles, and other measures, means a range that is ±10% of the stated value, more preferably ±5% of the stated value, and most preferably ±1% of the stated value, including all subranges therebetween.

It should be understood that the foregoing description is only illustrative of the present disclosure. Various alternatives, combinations and modifications can be devised by those skilled in the art without departing from the disclosure. Accordingly, the present disclosure is intended to embrace all such alternatives, modifications and variances that fall within the scope of this description.

What is claimed is:

1. A method for treating an area of landscape to kill ticks and/or other vectors in the treatment area, comprising:
applying heated water in a spray to the treatment area by an applicator,
wherein the heated water has a temperature at a point of impact with the treatment area that is about 145° F. to about 155° F. to kill ticks and/or other vectors in the treatment area,
wherein the angle of descent of the heated water is between about 45° to about 55° at the point of impact at the treatment area, and
wherein the flow rate and water pressure of the heated water at the point of impact drench the treatment area with the heated water to kill ticks and/or other vectors.

2. The method according to claim 1, wherein the heated water is the killing agent of the ticks and/or other vectors.

3. The method according to claim 1, wherein the flow rate and pressure of the heated water do not propel the ticks and/or other vectors to safety outside of the treatment area.

4. The method according to claim 1, wherein the heated water is applied through a nozzle that produces a fan-shaped stream of water to the treatment area.

5. The method according to claim 4, wherein an applicator holds the nozzle at an upward angle to create an arc of heated water that contacts the treatment area at an effective angle of descent to kill the ticks and/or other vectors therein.

6. The method according to claim 5, wherein the nozzle is positioned by an applicator to contact the treatment area at a distance of about 25 feet to about 30 feet from the nozzle tip.

7. The method according to claim 1, wherein the flow rate of the heated water is from about 25 to 30 gallons per minute.

8. The method according to claim 1, further comprising:
pre-treating a pre-treatment area containing heat-sensitive vegetation by spraying heated water in a portable water tank reservoir that is carried to the pre-treatment area by the administrator,
wherein the temperature of heated water for pre-treatment is between about 120° F. to about 130° F. at the point of impact.

9. The method according to claim 8, wherein said portable water tank reservoir is insulated but does not contain a heating element.

10. The method according to claim 8, wherein the heated water for pre-treating uses only the pressure of gravity feed from the portable water tank reservoir to spray the heated water on the heat-sensitive vegetation in the pre-treatment area.

11. The method according to claim 1, wherein the point of impact of the heated water is between ground level and four (4) feet above the ground to kill the ticks and/or other vectors in the treatment area.

12. The method according to claim 1, further comprising:
pre-heating the water by contacting the water with a first heating element that is positioned on a vehicle located near the treatment area;
feeding the pre-heated water through an insulated hose to a nozzle; and
adjusting the temperature of the pre-heated water inside the nozzle to an effective temperature to kill ticks and/or other vectors by contacting the pre-heated water in the nozzle with a second heating element inside the nozzle.

13. The method according to claim 1, wherein the flow rate and low pressure of the heated water combine to kill ticks and/or other vectors on their perch, or on the ground immediately below their perch, by direct contact with the heated water.

14. A nozzle for spraying heated water on a treatment area to kill ticks and/or other vectors, comprising:
a nozzle head;
a nozzle tip that has a nozzle tip opening through which the heated water exits the nozzle;
a water-in chamber; and
a wiring and component housing unit opposite the nozzle tip,
wherein the nozzle tip opening is smaller than the water-in chamber to create an amount of back pressure.

15. The nozzle according to claim 14, wherein the nozzle tip is flared and flattened at the nozzle tip opening.

16. The nozzle according to claim 15, wherein the nozzle tip further comprises one or more ribs that extend across an extent of the nozzle tip opening to create one or more water paths in the nozzle tip.

17. The nozzle according to claim 16, wherein the one or more water paths produce a straightening effect on the stream of heated water exiting the nozzle.

18. The nozzle according to claim 14, further comprising a heating element inside the nozzle head.

19. The nozzle according to claim 18, wherein the wiring and component housing unit has a control that manually adjusts temperature or flow rate of the heated water inside the nozzle.

20. The nozzle according to claim 14, further comprising a thermostat that measures the temperature of the heated water in the nozzle tip.
